(19) United States
(12) Patent Application Publication
(10) Pub. No.: US 2019/0190629 A1
(43) Pub. Date: Jun. 20, 2019

(54) INTERFERENCE PROCESSING METHOD AND DEVICE FOR CELL SIGNALS

(71) Applicant: ZTE Corporation, Shenzhen, GD (CN)

(72) Inventor: Jun LIN, Shenzhen (CN)

(21) Appl. No.: 16/323,086

(22) PCT Filed: Jan. 5, 2017
(86) PCT No.: PCT/CN2017/070288

§ 371 Date: Feb. 4, 2019

(30) Foreign Application Priority Data
Aug. 4, 2016 (CN) 201610632734.0

(51) Int. Cl. H04B 17/336; H04W 24/08; H04W 24/10

(52) U.S. Cl. CPC H04B 17/336; H04W 24/10; H04W 24/08

(57) ABSTRACT

An interference processing method includes: detecting whether the terminal is in the radio resource control (RRC) connection state; when the terminal is in the RRC connection state and a difference between an interference power of a cell reference signal (CRS) of a service cell and an interference power of a non-CRS of the service cell is greater than a first preset threshold, performing an interference correction processing of a current channel quality indication (CQI) of the service cell to acquire a corrected CQI and feed back the corrected CQI to a base station, which enables the base station to acquire a CQI and to schedule resources.

### TECHNICAL FIELD

The disclosure relates to the technical field of communication application, in particular to an interference processing method and device for cell signals.

### BACKGROUND

In Long Term Evolution (LTE) system, there are multiple cells with the same frequency band in the same location. If cell reference signals (CRS) of adjacent cells overlaps with each other, CRS interferes with each other, resulting in a reduction of cell coverage, a decrease of system throughput and a decrease of terminal communication rate.

CRS overlap in adjacent cells can be avoided by time and frequency offset, but time in a time division duplex (TDD) LTE system is strictly aligned and overlap can only be avoided by frequency offset; the number of frequency offsets is limited, generally three, that is to say, when a terminal receives signals from more than three cells at the same time, there must be CRS overlap from two cells, resulting in a reduction of system capacity.

When the TDD-LTE system is networked, engineers will try to avoid the presence of more than three cell signals with comparable power in the coverage area. Because of a complex terrain, an unbalanced load, design problems, limited frequency resources and other reasons, it is unavoidable that many areas are covered by multiple cells at the same time, resulting in CRS overlap, reducing the system capacity. Meanwhile, a communication mode for a user is also changing, and the communication terminal has entered areas that have not been planned and tested in detail, such as a space area of 30-50 meters above the ground. Such areas are not taking into consideration in networking, but a large number of Unmanned Aerial Vehicles (UAVs) bring mobile terminals to these areas. Due to high altitude signals have a small attenuation and a large transmission distance, there are a large number of cell signals in these areas, which inevitably leads to overlaps in terms of pilot signals. When the terminal initiates data communication in such areas, the data rate decreases and the system communication capacity decreases.

An essential problem for a decline in communication capability is that after pilot signals have overlapped, the noise measured by the terminal from pilot signals is higher than an actual noise. After the noise is reported to the network, the network schedules resources to the terminal according to the measured noise level. Because of the high noise and less scheduling resources, the communication rate decreases, and a throughput of the whole system decreases due to a low efficiency of resource utilization.

### SUMMARY

In accordance of an aspect of the present disclosure, an interference processing method and device for cell signals is provided to solve the problem that a channel quality measurement is inaccurate when a pilot signal of a cell is disturbed, which leads to a declined communication rate.

An embodiment of the disclosure provides an interference processing method for cell signals, including:

detecting whether a terminal is in a radio resource control (RRC) connection state;

performing, when the terminal is in the RRC connection state and a difference between an interference power of a cell reference signal (CRS) of a service cell and an interference power of a non-CRS of the service cell is greater than a first preset threshold, an interference correction processing of a current channel quality indication (CQI) of the service cell to acquire a corrected CQI and feed back the corrected CQI to a base station.

Wherein, a step of, when the terminal is in a RRC connection state and a difference between an interference power of a cell reference signal (CRS) of a service cell and an interference power of a non-CRS of the service cell is greater than a first preset threshold, performing an interference correction processing of a current channel quality indication (CQI) of the service cell to acquire a corrected CQI and feed back the corrected CQI to a base station includes:

when the terminal is in the RRC connection state and the difference between the interference power of the cell reference signal (CRS) of the service cell and the interference power of the non-CRS of the service cell is greater than the first preset threshold, acquiring a first pilot signal transmitted by the base station, and performing an interference correction processing of a current channel quality indicator (CQI) of the service cell according to the first pilot signal to acquire a corrected CQI and feed back the corrected CQI to the base station, wherein, the first pilot signal does not overlap with CRSs of adjacent cells of the service cell.

Wherein, steps of, when the terminal is in the RRC connection state and the difference between the interference power of the cell reference signal (CRS) of the service cell and the interference power of the non-CRS of the service cell is greater than the first preset threshold, acquiring a first pilot signal transmitted by the base station, and performing an interference correction processing of a current channel quality indicator (CQI) of the service cell according to the first pilot signal to acquire a corrected CQI and feed back the corrected CQI to the base station include:

when the terminal is in the RRC connection state and an overlap between a CRS of the service cell and a CRS of an adjacent cell of the service cell is detected, acquiring a dedicated reference signal (DRS) transmitted by the base station, wherein the DRS does not overlap with the CRS of the adjacent cell;

calculating a signal-to-noise ratio of the DRS according to the DRS;

acquiring a corrected CQI for the service cell according to the signal-to-noise ratio of the DRS, and feeding back the corrected CQI to the base station.

Wherein, a step of, when the terminal is in a RRC connection state and a difference between an interference power of a cell reference signal (CRS) of a service cell and an interference power of a non-CRS of the service cell is greater than a first preset threshold, performing an interference correction processing of a current channel quality indication (CQI) of the service cell to acquire a corrected CQI and feed back to a base station includes:

when the terminal is in the RRC connection state and the difference between the interference power of the cell reference signal (CRS) of the service cell and the interference power of a non-CRS of the service cell is greater than the first preset threshold, performing an interference correction processing of a current channel quality indication (CQI) of the service cell according to data transmission statistics information of a terminal transmission channel to acquire a corrected CQI and feed back the corrected CQI to a base station, wherein, the data transmission statistics information includes a total number of data packets transmitted by the terminal transmission channel in a preset time and a number of data packets that have failed to be transmitted.

Wherein, steps of, performing an interference correction processing of a current channel quality indication (CQI) of the service cell according to data transmission statistics information of a terminal transmission channel to acquire a corrected CQI and feed back the corrected CQI to a base station include:

updating the current CQI of the service cell to a first CQI according to a preset maximum CQI offset and reporting the first CQI to the base station, wherein, the first CQI is greater than the current CQI of the service cell, and the difference between the first CQI and the current CQI of the service cell is less than or equal to the maximum CQI offset;

counting the total number of data packets transmitted by the terminal transmission channel and the number of data packets failed to be transmitted in the preset time after reporting the first CQI;

acquiring a block error rate of the terminal transmission channel in the preset time according to a ratio of the number of data packets that failed to be transmitted to the total number of data packets transmitted by the terminal;

performing an interference correction processing of a current channel quality indication (CQI) of the service cell according to a relationship between the block error rate and a second preset threshold to acquire a corrected CQI; and

feeding back the corrected CQI to a base station.

Wherein, steps of, performing an interference correction processing of a current channel quality indication (CQI) of the service cell according to a relationship between the block error rate and a second preset threshold to acquire a corrected CQI and feed back the corrected CQI to a base station include:

when the block error rate is less than the second preset threshold, feeding back the first CQI as a corrected CQI to the base station;

when the block error rate is greater than or equal to the second preset threshold, reducing the first CQI to a second CQI and reporting the second CQI to the base station, and feeding back the second CQI as a corrected CQI to the base station when the block error rate of the terminal transmission channel is less than the second preset threshold in the preset time of reporting the second CQI.

Wherein, the interference processing method for cell signals further includes:

when the terminal is in a RRC disconnected state and there are CRS overlapping cells in a plurality of cells to be resided, correcting S values of the plurality of cells to be resided; and

making a residence selection according to the corrected S values, wherein the S values of cells to be resided are calculated according to a S criterion for cell selection.

Wherein, steps of, correcting S values of the plurality the cells to be resided and making a residence selection according to the corrected S values include:

subtracting a preset offset from the S values of the CRS overlapping cells, to acquire corrected S values of the plurality of the cells to be resided;

ranking the corrected S values of the plurality of the cells to be resided according to a preset order; and

selecting a cell to be resided with a largest S-value for resident.

An embodiment of the disclosure provides an interference processing device for cell signals, including:

a detecting module, configured to detect whether a terminal is in a radio resource control (RRC) connection state.

a first determining module, configured to perform an interference correction processing of a current channel quality indication (CQI) of the service cell to acquire a corrected CQI and feed back the corrected CQI to a base station, when the terminal is in the RRC connection state and a difference between an interference power of a cell reference signal (CRS) of a service cell and an interference power of a non-CRS of the service cell is greater than a first preset threshold.

Wherein, the first determining module is configured to acquire a first pilot signal transmitted by the base station, and perform an interference correction processing of a current channel quality indication (CQI) of the service cell according to the first pilot signal to acquire a corrected CQI and feed back the corrected CQI to a base station, when the terminal is in the RRC connection state and the difference between the interference power of the cell reference signal CRS of the service cell and the interference power of the non-CRS of the service cell is greater than a first preset threshold, wherein the first pilot signal does not overlap with CRSs of adjacent cells of the service cell.

Wherein, the first determining module is configured to perform an interference correction processing of a current channel quality indication (CQI) of the service cell according to data transmission statistics information of a terminal transmission channel to acquire a corrected CQI and feed back the corrected CQI to a base station, wherein, the data transmission statistics information includes a total number of data packets transmitted by the terminal transmission channel in a preset time and a number of data packets that have failed to be transmitted.

The embodiments of the present disclosure have the following beneficial effects:

In the technical scheme of the embodiment of the present disclosure, through detecting whether the terminal is in the RRC connection state of the wireless resource, performing the interference correction processing for the current channel quality indicator CQI of the service cell to acquire a corrected CQI and feed back the corrected CQI to a base station when the terminal is in the RRC connection state and the difference between the interference power of the cell reference signal CRS of the service cell and the interference power of the non-CRS of the service cell is greater than the first preset threshold, the base station can acquire a more accurate CQI and can schedule resources reasonably, thereby improving a resource utilization and a communication rate.

### BRIEF DESCRIPTION OF THE DRAWINGS

FIG. 1 is a schematic diagram of a resource block in an embodiment of the present disclosure.

FIG. 2 is a first workflow diagram of an interference processing method for cell signals in an embodiment of the present disclosure.

FIG. 3 is a second workflow diagram of an interference processing method for cell signals in an embodiment of the present disclosure.

FIG. 4 is a third workflow diagram of an interference processing method for a cell signal in an embodiment of the present disclosure.

FIG. 5 is a fourth workflow diagram of an interference processing method for cell signals in an embodiment of the present disclosure.

FIG. 6 is a block diagram of an interference processing device for cell signals in an embodiment of the present disclosure.

### DETAILED DESCRIPTION

In order to make the technical problems, technical schemes and advantages to be solved by the present disclosure clearer, detailed description will be followed in connection with specific embodiments and drawings.

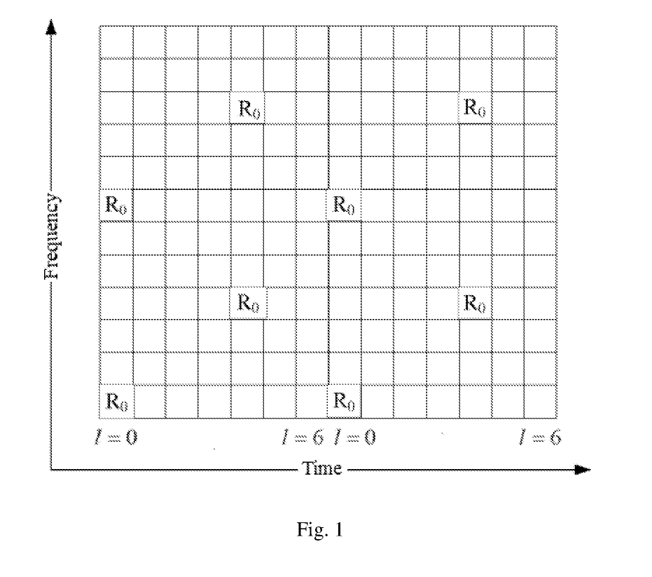

A basic transmission unit of LTE is Resource Element (RE), which has a bandwidth of 15 KHz in frequency domain and a duration of 71 microseconds in time domain. A minimum unit of LTE resource scheduling is Resource Block (RB). One RB has 12 REs in frequency domain and 14 REs in time domain. FIG. 1 shows the structure of RB, which contains 168 REs.

In theory, the terminal should calculate the signal-to-noise ratio (SNR) of each RE in RB to acquire an average SNR of the whole RB, and then acquire a channel quality indication based on the average SNR and feedback the channel quality indication to the base station. However, the terminal can not accurately measure the SNR of each RE. Therefore, the terminal estimates the average SNR of the whole RB according to the signal-to-noise ratio of reference REs designed in the LTE system. FIG. 1 shows a distribution of reference REs in RB for a single antenna LTE system, where RO represents reference RE, known as RS, it is also called CRS for it directs to all terminals in the cell. Reference REs have the characteristics of small number, uniform distribution, a determined signal modulation information and higher signal intensity than other REs.

Since the reference REs are uniformly distributed, if the interference signals are uniformly distributed throughout the RB, the channel quality of the whole RB may be estimated according to the signal quality of the reference REs. However, if the interference signals are not randomly distributed, the channel quality estimated through reference REs may be inaccurate, possibly higher or lower.

In a typical RB power distribution, the power of a reference RE is generally 3 to 5 dB higher than the average power of the RB, so as to increase the coverage of the cell. Assuming that the terminal receives signals of A and B cells, when the terminal decodes the signals of the A cells, the signals of the B cells are interference to the terminal. If the power distributions of reference RE and other RE (non-reference RE) of LTE signals in the B cells are not uniform, then the interference distribution of the B cells to the A cells is not uniform, and the reference REs of the B cells have a largest interference to the A cells.

If the reference REs of the B cells and the reference REs of the A cells just overlap, then the reference REs of the A cells suffer the most interference. Because the signal-to-noise ratio calculated from the reference REs of the A cells is inconsistent with the average signal-to-noise ratio of the A cells, the signal-to-noise ratio estimated from the reference REs is lower than the average signal-to-noise ratio. The terminal reports CQI according to the estimated SNR and the base station schedules resources accordingly, the coding rate and the modulation order will be reduced, resulting in a decreased throughput of the system.

Therefore, the embodiment of the present disclosure provides a interference processing method and device for cell signals, to solves the problem that the channel quality measurement is inaccurate when the pilot signal of the cell is interfered, which leads to a decreased communication rate.

### A First Embodiment

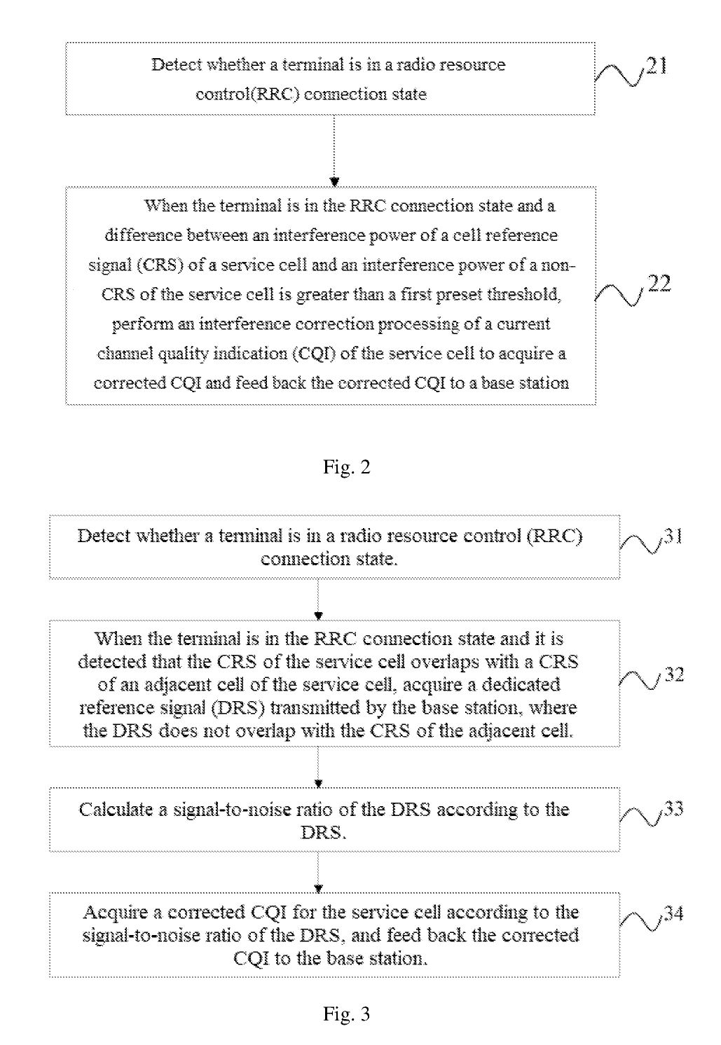

As shown in FIG. 2, the interference processing method of the cell signals in the embodiment of the present disclosure, the method includes Step 21 and Step 22.

Step 21: detect whether a terminal is in a radio resource control (RRC) connection state.

Step 22: when the terminal is in the RRC connection state and a difference between an interference power of a cell reference signal (CRS) of a service cell and an interference power of a non-CRS of the service cell is greater than a first preset threshold, perform an interference correction processing of a current channel quality indication (CQI) of the service cell to acquire a corrected CQI and feed back the corrected CQI to a base station.

Here, the difference between the interference power of the cell reference signal CRS in the service cell and the interference power of the non-CRS in the service cell is larger than the first preset threshold, which can be embodied in the overlap of the cell reference signal CRS in the service cell and the CRS in the adjacent cell (time and frequency overlap). The first preset threshold can be set based on a difference between the power of the CRS in the adjacent cell and the average power of the REs in the adjacent cell. Specifically, step 22 may include: when the terminal is in a RRC connection state and a difference between an interference power of a cell reference signal (CRS) of the service cell and an interference power of a non-CRS of the service cell is greater than a first preset threshold, acquiring a first pilot signal transmitted by the base station, and performing an interference correction processing of a current channel quality indicator (CQI) of the service cell according to the first pilot signal to acquire a corrected CQI and feed back the corrected CQI to a base station, where, the first pilot signal does not overlap with CRSs of adjacent cells of the service cell; or

performing an interference correction processing of a current channel quality indication (CQI) of the service cell according to data transmission statistics information of a terminal transmission channel to acquire a corrected CQI and feed back the corrected CQI to a base station, where, the data transmission statistics information includes a total number of data packets transmitted by the terminal transmission channel in a preset time and a number of data packets that have failed to be transmitted.

Here, the first pilot signal or the data transmission statistics information of the terminal transmission channel is used to correct the current CQI of the service cell, so that the base station can acquire an accurate CQI.

In the interference processing method of the cell signals provided by the embodiment of the present disclosure, through detecting whether the terminal is in the RRC connection state of the wireless resource, performing the interference correction processing for the current channel quality indicator CQI of the service cell to acquire a corrected CQI and feed back the corrected CQI to a base station when the terminal is in the RRC connection state and the difference between the interference power of the cell reference signal CRS of the service cell and the interference power of the non-CRS of the service cell is greater than the first preset threshold, the base station can acquire a more accurate CQI and can schedule resources reasonably, thereby improving a resource utilization and a communication rate.

### A Second Embodiment

when the terminal is in a RRC connection state and a difference between an interference power of a cell reference signal (CRS) of the service cell and an interference power of a non-CRS of the service cell is greater than a first preset threshold, a first pilot signal transmitted by the base station may be acquired. An interference correction processing of a current channel quality indicator (CQI) of the service cell may be performed according to the first pilot signal to acquire a corrected CQI, and the corrected CQI may be feed back to a base station, where, the first pilot signal does not overlap with CRSs of adjacent cells of the service cell.

As shown in FIG. 3, embodiments of the present disclosure provide an interference processing method for cell signals, and the method includes step 31 and step 32.

Step 31: detect whether a terminal is in a radio resource control (RRC) connection state.

Step 32: when the terminal is in the RRC connection state and it is detected that the CRS of the service cell overlaps with a CRS of an adjacent cell of the service cell, acquire a dedicated reference signal (DRS) transmitted by the base station, where the DRS does not overlap with the CRS of the adjacent cell.

Specifically, the terminal instructs the base station to switch the transmission mode by means of measuring reports or special instructions; the base station uses a new transmission mode, in which the signal transmitted by the base station includes a special pilot (dedicated reference signal, DRS).

Assuming the CRS power of the service cell is −100 dBm, the actual average SNR of the service cell is 3 dB, the CRS power of the adjacent cell is −100 dBm, and the average power of the REs of the adjacent cell is −103 dBm. When the terminal receives the signal of service cell, the signal of adjacent cell is interference and noise. Based on whether CRSs between service cell and adjacent cell overlap, the SNR estimated by terminal according to CRS is different.

If the CRSs of service cell and adjacent cell do not overlap, the adjacent cell interferes with the CRS of service cell with average power. The signal-to-noise ratio is calculated SNR=3 dB, which is consistent with the expected results.

If the CRSs of the service cell and the adjacent cell overlap, the adjacent cell interferes with the CRS of the service cell with its CRS power. The signal-to-noise ratio is calculated, SNR=0 dB, which is 3 dB lower than the actual result.

The SNR calculated in the above two cases is different, and the reported CQI is different. For the CQI reported in the former case, the service cell can achieve the most efficient scheduling of resources; for the CQI reported in the latter case, the service cell will reduce the coding rate, reduce the modulation order, and do not affect the terminal decoding, but reduce the resource utilization efficiency, affect the system throughput. Moreover, the greater the CRS power compared with the average RE power in RB, the greater impact on the system.

In addition, the RE power corresponding to CRS in real environment is higher than the average power of REs in the whole RB.

1. In order to increase the coverage of LTE cells, the RE power of CRS is 3-5 dB higher than the average power of REs in RB.

2. CRS in LTE cell is continuously transmitted, while RB is not running at full load, and the actual average power is lower than the maximum average power.

Considering the above two conditions, the reference RE power is higher than the average RE power in RB, generally more than 5 dB. If the reference RE of the adjacent cell and the reference RE of the service cell overlap, and the adjacent cell is a main interference source of the service cell, the CQI estimated by the terminal using the SNR of the reference RE of the service cell is inaccurate. The terminal can estimate the power distribution of each RE in the adjacent cell by various methods, such as directly estimating the difference between the reference RE and the average RE by a system parameter p-b of the adjacent cell. In a specific embodiment of the present disclosure, a p-b value of a cell broadcast parameter can be acquired by receiving a broadcast message of the cell. Reference RE power allocation is determined by the p-b value when the base station transmits a signal at full power. For example, pb=1 indicates that the reference RE power is 3 dB higher than the average power of RB.

In addition, if the main source of interference to the service cell is not the adjacent LTE cell, a uniformity of a noise distribution can be estimated by various signal detection strategies, such as detecting the power of REs in RB one by one when the service cell is idle.

Step 33: calculate a signal-to-noise ratio of the DRS according to the DRS.

Step 34: acquire a corrected CQI for the service cell according to the signal-to-noise ratio of the DRS, and feed back the corrected CQI to the base station.

In the interference processing method of cell signal provided by the embodiment of the present disclosure, if the terminal is in the RRC connection state and an overlap of the CRS of the service cell and the CRS of the adjacent cell of the service cell is detected, the CQI calculated by the terminal according to the SNR of the CRS of the service cell is not the actual CQI, the terminal instructs the base station to change the transmission mode, and the base station in the new transmission mode, transmits the dedicated pilot. The terminal acquires the CQI according to the SNR of the dedicated pilot and reports it to the base station. CQI calculated based on dedicated pilot eliminates pilot interference, and the base station can schedule resources according to the actual communication environment of the terminal, thereby increasing a transmission rate of the terminal and a system throughput.

### A Third Embodiment

When the terminal is in the RRC connection state and the difference between the interference power of the CRS of the service cell and the interference power of the non-CRS of the service cell is greater than the first preset threshold, the current CQI of the service cell can be corrected according to the data transmission statistics information of the terminal transmission channel, and the corrected CQI can be acquired and fed back to the base station. Data transmission statistics information includes a total number of data packets transmitted by the terminal transmission channel in a preset time and a number of data packets that have failed to be transmitted.

As shown in FIG. 4, embodiments of the present disclosure provide an interference processing method for cell signals, and the method includes step 41 and step 42.

Step 41: detect whether the terminal is in a RRC connection state of wireless resource.

Step 42: when the terminal is in the RRC connection state and the difference between the interference power of the CRS of the service cell and the interference power of the non-CRS of the service cell is greater than the first preset threshold, update the current CQI of the service cell to a first CQI according to a preset maximum CQI offset, and reporting the first CQI to the base station, wherein, the first CQI is greater than the current CQI of the service cell, and the difference between the first CQI and the current CQI of the service cell is less than or equal to the maximum CQI offset.

Here, if the terminal is in the RRC connection state, and detects that an adjacent cell is presented with a difference between a signal strength of the adjacent cell and a signal strength of the service cell being less than 5 dB, and the CRS of the adjacent cell and the CRS of the service cell overlap, the terminal reads a p-b parameter of a broadcast message of the adjacent cell. If the p-b parameter of the broadcast message of the adjacent cell is 3 (this parameter represents that the signal is transmitted by the adjacent cell at full load). The CRS power is 6 dB higher than the average power of REs in RB. According to this value, a maximum offset of CQI is calculated to be 5.

Step 43: count the total number of data packets transmitted by the terminal transmission channel and the number of data packets failed to be transmitted in the preset time after reporting the first CQI.

Specifically, before reporting a next CQI, the terminal counts the total number of data packets transmitted by the terminal transmission channel and the number of data packets failed to be transmitted.

Step 44: acquire a block error rate of the terminal transmission channel in the preset time according to a ratio of the number of data packets that failed to be transmitted to the total number of data packets transmitted by the terminal.

Step 45: perform an interference correction processing of a current CQI of the service cell according to a relationship between the block error rate and a second preset threshold to acquire a corrected CQI and feed back the corrected CQI to a base station.

Specifically, the above step 45 includes step 451 and step 452.

Step 451: if the block error rate is less than the second preset threshold, feed back the first CQI as a corrected CQI to the base station.

Step 452: if the block error rate is greater than or equal to the second preset threshold, reduce the first CQI to a second CQI and report the second CQI to the base station, and feed back the second CQI as a corrected CQI to the base station when the block error rate of the terminal transmission channel is less than the second preset threshold in the preset time of reporting the second CQI.

Specifically, the first CQI can be acquired by adding the current CQI of the service cell and the maximum offset of CQI. The error block rate of the terminal transmission channel after reporting the first CQI is calculated. If the error block rate of the terminal transmission channel is greater than the second preset threshold, the first CQI can be subtracted by 1, to acquire the second CQI. The error block rate of the terminal transmission channel after reporting the first CQI may be further calculated. If the error block rate is still greater than the second preset threshold, the second CQI can be subtracted by 1 continuously until the error block rate calculated according to the updated CQI is less than the second preset threshold, and the last updated CQI is fed back to the base station as the corrected CQI.

In the embodiment of the present disclosure, as the CQI calculated based on the CRS of the service cell is inaccurate, the maximum offset calculated based on the broadcast message is inaccurate, and the environment is constantly changing, a situation that the error block rate exceeds the threshold may occur when the CQI offset of the terminal is 4, which indicates that the offset of the terminal is too large and the CQI offset needs to be reduced. Moreover, as the CQI value reported in the embodiment of the present disclosure is large, the rate for the base station scheduling resources to the terminal is increased, the system throughput of the base station is increased, and the cell coverage radius is improved.

### A Fourth Embodiment

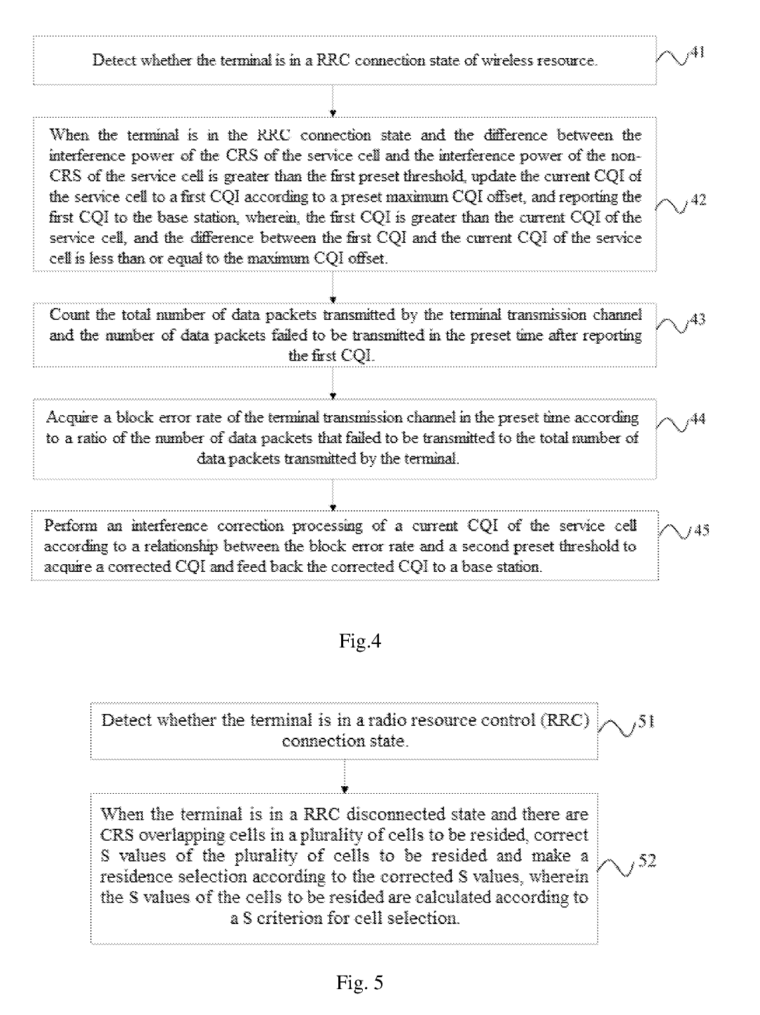

As shown in FIG. 5, embodiments of the present disclosure provide an interference processing method for cell signals, and the method includes step 51 and step 52.

Step 51: detect whether the terminal is in a radio resource control (RRC) connection state.

Step 52: when the terminal is in a RRC disconnected state and there are CRS overlapping cells in a plurality of cells to be resided, correct S values of the plurality of cells to be resided and make a residence selection according to the corrected S values, wherein the S values of the cells to be resided are calculated according to a S criterion for cell selection.

Specifically, a preset offset is subtracted from the S values of the CRS overlapping cells, to acquire corrected S values of the plurality of the cells to be resided; the corrected S values of the plurality of the cells to be resided are ranked according to a preset order, and a cell to be resided with a largest S-value for resident is selected.

In the interference processing method of cell signal provided by the embodiment of the present disclosure, the terminal needs to conduct periodic cell selection or re-selection when the terminal is in the idle state of RRC, and calculate the S criterion according to the parameters given by the broadcast message; the S criterion is generally calculated based on the reference signal reception power (RSRP) and the LTE reference signal reception quality (RSRQ); the calculation criterion mainly reflects the strength of cell signal, and is not directly related to the CRS signal-to-noise ratio of the terminal; if there is CRS overlap in terms of the cells, the signal-to-noise ratio of the CRS will deteriorate seriously, and if the terminal initiates data connection in the cell, the data transmission rate will also be low. In the embodiment of the disclosure, the cell selection and re-selection process are optimized, and the strength of CRS signal is reduced by modifying the S criterion. However, for the priority of the cells with poor signal-to-noise ratio, the cell with more uniform noise distribution can be re-selected by the terminal, thereby reducing pilot interference.

### A Fifth Embodiment

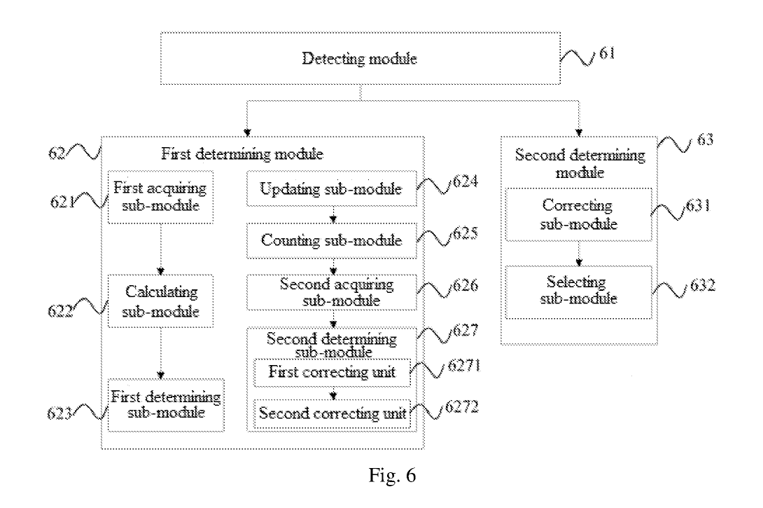

As shown in FIG. 6, embodiments of the present disclosure also provide an interference processing device for cell signals, and the device includes a detecting module 61, and a first determining module 62.

The detecting module 61 is configured to detect whether a terminal is in a RRC connection state of the wireless resource.

The first determining module 62 is configured to perform an interference correction processing of a current channel quality indication (CQI) of the service cell to acquire a corrected CQI and feed back the corrected CQI to a base station, when the terminal is in the RRC connection state and a difference between an interference power of a cell reference signal (CRS) of a service cell and an interference power of a non-CRS of the service cell is greater than a first preset threshold.

In the interference processing device for cell signals provided by the embodiments of the disclosure, the first determining module 62 is configured to acquire a first pilot signal transmitted by the base station, and perform an interference correction processing of a current channel quality indication (CQI) of the service cell according to the first pilot signal to acquire a corrected CQI and feed back the corrected CQI to a base station, when the terminal is in the RRC connection state and the difference between the interference power of the cell reference signal CRS of the service cell and the interference power of the non-CRS of the service cell is greater than a first preset threshold, wherein the first pilot signal does not overlap with CRSs of adjacent cells of the service cell.

In the interference processing device of the cell signal according to the embodiment of the present disclosure, the first determining module 62 includes: a first acquiring sub-module 621, a calculating sub-module 622, and a first determining sub-module 623.

The first acquiring sub-module 621 is configured to acquire the dedicated reference signal (DRS) sent by the base station if the terminal is in the RRC connection state and an overlap between a CRS of the service cell and a CRS of the adjacent cell of the service cell is detected, where the DRS does not overlap with the CRS of the adjacent cell.

The calculating sub-module 622 is configured to calculate a signal-to-noise ratio of the DRS according to the DRS.

The first determining sub-module 623 is configured to acquire a corrected CQI for the service cell according to the signal-to-noise ratio of the DRS, and feed back the corrected CQI to the base station.

In the interference processing device for cell signals provided by the embodiment of the present disclosure, the first determining module 62, is configured to, perform, when the terminal is in a RRC connection state and a difference between an interference power of a cell reference signal (CRS) of the service cell and an interference power of a non-CRS of the service cell is greater than a first preset threshold, an interference correction processing of a current channel quality indication (CQI) of the service cell according to data transmission statistics information of a terminal transmission channel to acquire a corrected CQI and feed back the corrected CQI to a base station, wherein, the data transmission statistics information includes a total number of data packets transmitted by the terminal transmission channel in a preset time and a number of data packets that have failed to be transmitted.

In the interference processing device of the cell signal according to the embodiment of the present disclosure, the first determining module 62 includes: a updating sub-module 624, a counting sub-module 625, a second acquiring sub-module 626 and a second determining sub-module 627.

The updating sub-module 624 is configured to update the current CQI of the service cell to a first CQI according to a preset maximum CQI offset and report the first CQI to the base station, wherein, the first CQI is greater than the current CQI of the service cell, and the difference between the first CQI and the current CQI of the service cell is less than or equal to the maximum CQI offset.

The counting sub-module 625 is configured to count the total number of data packets transmitted by the terminal transmission channel and the number of data packets failed to be transmitted in the preset time after reporting the first CQI.

The second acquiring sub-module 626 is configured to acquire a block error rate of the terminal transmission channel in the preset time according to a ratio of the number of data packets that failed to be transmitted to the total number of data packets transmitted by the terminal.

The second determining sub-module 627 is configured to perform an interference correction processing of a current channel quality indication (CQI) of the service cell according to a relationship between the block error rate and a second preset threshold to acquire a corrected CQI and feed back the corrected CQI to a base station

In the interference processing device of the cell signal according to the embodiment of the present disclosure, the second determining sub-module 627 includes: a first correcting unit 6271 and a second correcting unit 6272.

The first correcting unit 6271 is configured to feed back, when the block error rate is less than the second preset threshold, the first CQI as a corrected CQI to the base station.

The second correcting unit 6272 is configured to, reduce, when the block error rate is greater than or equal to the second preset threshold, the first CQI to a second CQI and report the second CQI to the base station, and feed back the second CQI as a corrected CQI to the base station when the block error rate of the terminal transmission channel is less than the second preset threshold in the preset time of reporting the second CQI. Where, the second CQI is larger than the current CQI of the service cell.

The interference processing device of the cell signal according to the embodiment of the present disclosure further includes:

a second determining module 63, configured to correct, when the terminal is in a RRC disconnected state and there are CRS overlapping cells in a plurality of cells to be resided, S values of the plurality of the cells to be resided and make a residence selection according to the corrected S values, wherein the S values of cells to be resided are calculated according to a S criterion for cell selection.

In the interference processing device of the cell signal according to the embodiment of the present disclosure, the second determining module 63 includes: a correcting sub-module 631 and a selecting sub-module 632.

The correcting sub-module 631 is configured to subtract a preset offset from the S values of the CRS overlapping cells, to acquire corrected S values of the plurality of the cells to be resided.

The selecting sub-module 632 is configured to rank the corrected S values of the plurality of the cells to be resided according to a preset order, and select a cell to be resided with a largest S-value for resident.

It should be noted that the device is a device corresponding to the above method embodiments. All the implementation manners in the above method embodiments are applicable to the implementation of the device and can achieve the same technical effect.

The disclosure also provides a non-temporary computer-readable storage medium, the non-temporary computer-readable storage medium stores instructions, when one or more processors of a interference processing device executes the instructions, the interference processing device executes a interference processing method for cell signal, the method includes:

(1) detect whether a terminal is in a radio resource control (RRC) connection state;

(2) performing, when the terminal is in the RRC connection state and a difference between an interference power of a cell reference signal (CRS) of a service cell and an interference power of a non-CRS of the service cell is greater than a first preset threshold, an interference correction processing of a current channel quality indication (CQI) of the service cell to acquire a corrected CQI and feed back the corrected CQI to a base station.

In the interference processing method and device of the cell signal provided by the embodiment of the present, through detecting whether the terminal is in the RRC connection state of the wireless resource, performing the interference correction processing for the current channel quality indicator CQI of the service cell to acquire a corrected CQI and feed back the corrected CQI to a base station when the terminal is in the RRC connection state and the difference between the interference power of the cell reference signal CRS of the service cell and the interference power of the non-CRS of the service cell is greater than the first preset threshold, the base station can acquire a more accurate CQI and can schedule resources reasonably, thereby improving a resource utilization and a communication rate.

Each module or unit in the interference processing device for the cell signal provided by the embodiment of this application may be implemented by one or more digital signal processors (DSPs), application specific integrated circuits (ASICs), processors, microprocessors, controllers, microcontrollers, field programmable arrays (FPGAs), programmable logic devices or other electronic units or any combination thereof. Some of the functions or processes described in the embodiments of this application may also be implemented by software executed on the processor.

### INDUSTRIAL APPLICABILITY

The disclosure relates to the technical field of communication application, which enables base stations to acquire relatively accurate CQI, to reasonably schedule resources, and to improve the resource utilization and the communication rate.

The above are only preferred embodiments of the present disclosure, and are not intended to limit the present disclosure. Any modification, equivalent replacement, improvement etc., made within the spirit and principles of the present disclosure shall be included in the scope of protection of the present disclosure.

1. An interference processing method for cell signals, comprising:
detecting whether a terminal is in a radio resource control (RRC) connection state;
performing, when the terminal is in the RRC connection state and a difference between an interference power of a cell reference signal (CRS) of a service cell and an interference power of a non-CRS of the service cell is greater than a first preset threshold, an interference correction processing of a current channel quality indication (CQI) of the service cell to acquire a corrected CQI and feed back the corrected CQI to a base station.

2. The interference processing method for cell signals according to claim 1, wherein, a step of, when the terminal is in a RRC connection state and a difference between an interference power of a cell reference signal (CRS) of a service cell and an interference power of a non-CRS of the service cell is greater than a first preset threshold, performing an interference correction processing of a current channel quality indication (CQI) of the service cell to acquire a corrected CQI and feed back the corrected CQI to a base station comprises:
when the terminal is in the RRC connection state and the difference between the interference power of the cell reference signal (CRS) of the service cell and the interference power of the non-CRS of the service cell is greater than the first preset threshold, acquiring a first pilot signal transmitted by the base station, and performing an interference correction processing of a current channel quality indicator (CQI) of the service cell according to the first pilot signal to acquire a corrected CQI and feed back the corrected CQI to the base station, wherein, the first pilot signal does not overlap with CRSs of adjacent cells of the service cell.

3. The interference processing method for cell signals according to claim 2, wherein, steps of, when the terminal is in the RRC connection state and the difference between the interference power of the cell reference signal (CRS) of the service cell and the interference power of the non-CRS of the service cell is greater than the first preset threshold, acquiring a first pilot signal transmitted by the base station, and performing an interference correction processing of a current channel quality indicator (CQI) of the service cell according to the first pilot signal to acquire a corrected CQI and feed back the corrected CQI to the base station comprise:
when the terminal is in the RRC connection state and an overlap between a CRS of the service cell and a CRS of an adjacent cell of the service cell is detected, acquiring a dedicated reference signal (DRS) transmitted by the base station, wherein the DRS does not overlap with the CRS of the adjacent cell;
calculating a signal-to-noise ratio of the DRS according to the DRS;
acquiring a corrected CQI for the service cell according to the signal-to-noise ratio of the DRS, and feed back the corrected CQI to the base station.

4. The interference processing method for cell signals according to claim 1, wherein, a step of, when the terminal is in a RRC connection state and a difference between an interference power of a cell reference signal (CRS) of a service cell and an interference power of a non-CRS of the service cell is greater than a first preset threshold, performing an interference correction processing of a current channel quality indication (CQI) of the service cell to acquire a corrected CQI and feed back the corrected CQI to a base station comprises:
when the terminal is in the RRC connection state and the difference between the interference power of the cell reference signal (CRS) of the service cell and the interference power of the non-CRS of the service cell is greater than the first preset threshold, performing an interference correction processing of a current channel quality indication (CQI) of the service cell according to data transmission statistics information of a terminal transmission channel to acquire a corrected CQI and feed back the corrected CQI to a base station, wherein, the data transmission statistics information comprises a total number of data packets transmitted by the terminal transmission channel in a preset time and a number of data packets that have failed to be transmitted.

5. The interference processing method for cell signals according to claim 4, wherein, steps of performing an interference correction processing of a current channel quality indication (CQI) of the service cell according to data transmission statistics information of a terminal transmission channel to acquire a corrected CQI and feed back the corrected CQI to a base station comprise:
updating the current CQI of the service cell to a first CQI according to a preset maximum CQI offset and reporting the first CQI to the base station, wherein, the first CQI is greater than the current CQI of the service cell, and the difference between the first CQI and the current CQI of the service cell is less than or equal to the maximum CQI offset;
counting the total number of data packets transmitted by the terminal transmission channel and the number of data packets failed to be transmitted in the preset time after reporting the first CQI;
acquiring a block error rate of the terminal transmission channel in the preset time according to a ratio of the number of data packets that failed to be transmitted to the total number of data packets transmitted by the terminal;
performing an interference correction processing of a current channel quality indication (CQI) of the service cell according to a relationship between the block error rate and a second preset threshold to acquire a corrected CQI; and
feeding back the corrected CQI to a base station.

6. The interference processing method for cell signals according to claim 5, wherein, steps of performing an interference correction processing of a current channel quality indication (CQI) of the service cell according to a relationship between the block error rate and a second preset threshold to acquire a corrected CQI and feed back the corrected CQI to a base station comprise:
when the block error rate is less than the second preset threshold, feeding back the first CQI as a corrected CQI to the base station;
when the block error rate is greater than or equal to the second preset threshold, reducing the first CQI to a second CQI and reporting the second CQI to the base station, and feeding back the second CQI as a corrected CQI to the base station when the block error rate of the terminal transmission channel is less than the second preset threshold in the preset time of reporting the second CQI, wherein, the second CQI is larger than the current CQI of the service cell.

7. The interference processing method for cell signals according to claim 1, further comprising:
when the terminal is in a RRC disconnected state and there are CRS overlapping cells in a plurality of cells to be resided, correcting S values of the plurality of the cells to be resided; and
making a residence selection according to the corrected S values, wherein the S values of cells to be resided are calculated according to a S criterion for cell selection.

8. The interference processing method for cell signals according to claim 7, wherein, steps of correcting S values of the plurality the cells to be resided and making a residence selection according to the corrected S values comprise:
subtracting a preset offset from the S values of the CRS overlapping cells, to acquire corrected S values of the plurality of the cells to be resided;
ranking the corrected S values of the plurality of the cells to be resided according to a preset order, and
selecting a cell to be resided with a largest S-value for resident.

9. A interference processing device for cell signals, comprising:
a detecting module, configured to detect whether a terminal is in a radio resource control (RRC) connection state.
a first determining module, configured to perform an interference correction processing of a current channel quality indication (CQI) of the service cell to acquire a corrected CQI and feed back the corrected CQI to a base station, when the terminal is in the RRC connection state and a difference between an interference power of a cell reference signal (CRS) of a service cell and an interference power of a non-CRS of the service cell is greater than a first preset threshold.

10. The interference processing device for cell signals according to claim 9, wherein, the first determining module is configured to acquire a first pilot signal transmitted by the base station, and perform an interference correction processing of a current channel quality indication (CQI) of the service cell according to the first pilot signal to acquire a corrected CQI and feed back the corrected CQI to a base station, when the terminal is in the RRC connection state and the difference between the interference power of the cell reference signal CRS of the service cell and the interference power of the non-CRS of the service cell is greater than a first preset threshold, wherein the first pilot signal does not overlap with CRSs of adjacent cells of the service cell.

11. The interference processing device for cell signals according to claim 9, wherein, the first determining module is configured to perform an interference correction processing of a current channel quality indication (CQI) of the service cell according to data transmission statistics information of a terminal transmission channel to acquire a corrected CQI and feed back the corrected CQI to a base station, wherein, the data transmission statistics information comprises a total number of data packets transmitted by the terminal transmission channel in a preset time and a number of data packets that have failed to be transmitted.

12. A non-temporary computer-readable storage medium, wherein the non-temporary computer-readable storage medium stores instructions, and when one or more processors of a interference processing device executes the instructions, the interference processing device executes a interference processing method for cell signals, the method comprising:
detecting whether a terminal is in a radio resource control (RRC) connection state;
performing, when the terminal is in the RRC connection state and a difference between an interference power of a cell reference signal (CRS) of a service cell and an interference power of a non-CRS of the service cell is greater than a first preset threshold, an interference correction processing of a current channel quality indication (CQI) of the service cell to acquire a corrected CQI and feed back the corrected CQI to a base station.
